(19) United States
(12) Patent Application Publication
(10) Pub. No.: US 2023/0253610 A1
(43) Pub. Date: Aug. 10, 2023

(54) BATTERY ASSEMBLIES COMPRISING LITHIUM-METAL ELECTROCHEMICAL CELLS AND LITHIUM-EJECTA CONTAINMENT COMPONENTS

(71) Applicant: Cuberg, Inc., San Leandro, CA (US)

(72) Inventors: Stephen Lawes, Oakland, CA (US); Edward Meyjes, Berkeley, CA (US); Seamus Bannon, Oakland, CA (US); Alex Beraud, San Francisco, CA (US); Luke Strohbehn, Berkeley, CA (US); Richard Wang, Danville, CA (US)

(73) Assignee: Cuberg, Inc., San Leandro, CA (US)

(21) Appl. No.: 17/650,442

(22) Filed: Feb. 9, 2022

(51) Int. Cl. H01M 10/052; H01M 4/38; H01M 10/056; H01M 10/615; H01M 50/105; H01M 50/204; H01M 4/66

(52) U.S. Cl. CPC H01M 10/052; H01M 4/382; H01M 10/056; H01M 10/615; H01M 50/105; H01M 50/204; H01M 4/661

(57) ABSTRACT

Described herein are battery assemblies that comprise lithium-metal electrochemical cells and lithium-ejecta containment components. A lithium-ejecta containment component is configured to prevent or at least reduce the migration of lithium metal that has been ejected from any of the lithium-metal electrochemical cells. For example, a lithium-ejecta containment component can be positioned between a pair of lithium-metal electrochemical cells and/or between the battery-assembly enclosure and each cell. In the same or other examples, a lithium-ejecta containment component can be integrated into the battery-assembly enclosure and/or cell enclosures. Furthermore, a lithium-ejecta containment component can be configured to absorb and contain the ejected lithium metal. In further examples, a lithium-ejecta containment component is configured to direct the ejected lithium metal away from the battery assembly. Various materials, which are resistant to lithium and capable of withstanding high temperatures, can be used for a lithium-ejecta containment component.

### BACKGROUND

Lithium-ion (Li-ion or Lil) cells or, more generally, Li-ion batteries are widely used for various applications. For example, Li-ion batteries are used to power devices as small as medical devices or cell phones and as large as electric vehicles or aircrafts. The wide adoption of Li-ion batteries across many industries generated many useful designs and knowledge about fabricating Li-ion battery modules and packs. In particular, many concerns involving cycling efficiency, capacity, and safety have been addressed in Li-ion batteries.

Lithium metal (Li-metal or LiM) cells represent a different battery type and are distinct from Li-ion cells. Specifically, Li-ion cells utilize special negative-electrode active materials (e.g., graphite, silicon) to trap lithium ions when the Li-ion cells are charging. On the other hand, Li-metal cells utilize the direct deposition (e.g., plating) of lithium metal on the negative current collectors without a need for any additional active materials for trapping lithium ions. As such, Li-metal cells tend to have a lower weight and a higher energy density in comparison to Li-ion cells. For example, Li-metal has a specific capacity of 3,860 mAh/g, which is about ten times higher than that of graphite.

However, Li-metal cells or, more generally, Li-metal batteries are currently not widely adopted at the scale of Li-ion batteries. For example, many safety aspects of Li-metal cells are still being addressed. As noted above, Li-metal cells can include large lithium-metal aggregates, which are not trapped in other materials and are generally not constrained on the negative electrodes. As such, Li-metal cells can have a unique failure mode that involves the generation and ejection of lithium metal from the cells, often in a molten state. This failure mode is not present in Li-ion batteries, since lithium is trapped inside negative active materials. Lithium metal and, in particular, molten lithium metal are highly reactive and can burn at temperatures of 1200° C. or more. Ejection of lithium metal from one cell can cause adjacent cells to enter thermal runaway if lithium metal is allowed to migrate within a battery assembly.

What is needed are new methods and devices of preventing or at least reducing the migration of lithium metal within battery assemblies once the lithium metal is ejected from lithium-metal electrochemical cells.

### SUMMARY

Described herein are battery assemblies that comprise lithium-metal electrochemical cells and lithium-ejecta containment components. A lithium-ejecta containment component is configured to prevent or at least reduce the migration of lithium metal that has been ejected from any of the lithium-metal electrochemical cells. For example, a lithium-ejecta containment component can be positioned between a pair of lithium-metal electrochemical cells and/or between the battery-assembly enclosure and each cell. In the same or other examples, a lithium-ejecta containment component can be integrated into the battery-assembly enclosure and/or cell enclosures. Furthermore, a lithium-ejecta containment component can be configured to absorb and contain the ejected lithium metal. In further examples, a lithium-ejecta containment component is configured to direct the ejected lithium metal away from the battery assembly. Various materials, which are resistant to lithium and capable of withstanding high temperatures, can be used for a lithium-ejecta containment component.

These and other embodiments are described further below with reference to the figures.

### BRIEF DESCRIPTION OF THE DRAWINGS

FIGS. 1A and 1B are two examples of a battery assembly, comprising lithium-metal electrochemical cells and a lithium-ejecta containment component.

FIG. 2 is an example of a lithium-metal electrochemical cell with a lithium-ejecta containment component integrated into a cell enclosure.

FIGS. 3A, 3B, and 3C and FIGS. 4A and 4B illustrate various examples of integrating a lithium-ejecta containment component into a battery assembly.

FIGS. 5A, 5B, and 5C are two examples of integrating a lithium-ejecta containment component into a battery assembly vent.

FIG. 6 is an example of integrating a lithium-ejecta containment component into a current-carrying component.

FIG. 7 is a block diagram of an aircraft comprising a battery assembly, which comprises lithium-metal electrochemical cells and a lithium-ejecta containment component, in accordance with some examples.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

### Introduction

As noted above, Li-metal cells have a unique design, in which lithium metal is deposited on the negative electrodes without being contained by or trapped inside other materials (e.g., graphite, which is commonly used Li-ion cells). Because of this unique design, Li-metal cells tend to have a lower weight and higher energy density in comparison to Li-ion cells. Both of these qualities are highly beneficial for many applications, such as aircraft, spacecraft, and the like. At the same time, this unique design can also cause a unique failure mode, associated with the generation and ejection of lithium metal from such cells. This failure mode causes various safety concerns, in particular, rapid propagation of this failure mode among different cells in the same assembly. The propagation is caused by the high reactivity and high burning temperature of the lithium metal. At the same time, most battery applications require safe and continuous battery operation while multiple individual cells are closely positioned together. As such, specific and unique measures are needed in battery assemblies formed with Li-metal cells. For example, these measures need to prevent the propagation of unsafe conditions within a battery assembly if lithium metal or, more specifically, molten lithium metal is ejected from one or more cells in this assembly.

A battery assembly may include multiple pouch, cylindrical, or prismatic battery cells that are stacked in one or more directions and are electrically interconnected (e.g., in series, parallel, and/or various combinations of in series and parallel connections). Depending on the number of cells, a battery assembly may be also referred to as a battery module (e.g., a few cells) or a battery pack (e.g., hundreds or thousands of cells). In some examples, a battery pack comprises several individual modules, each comprising multiple Li-metal cells. Furthermore, in a specific example, a battery assembly may include a single battery cell.

Because of the volumetric and mass requirements for many applications, individual cells within battery assemblies are packed as tightly together as possible, leaving minimal space, if any, between a pair of adjacent cells. This tight packing creates additional challenges with controlling the propagation of unsafe conditions among different cells, in particular when these conditions are caused by ejected lithium metal. For example, lithium metal, ejected from one cell, can quickly reach adjacent cells causing various damage, such as reactive with the external components of these adjacent cells, heating these cells, and causing external shorts of these cells (e.g., upon reaching the external terminals). At some point and if not sufficiently mitigated, this damage can cause the damaged cells to discharge additional lithium metal. The process can continue, which is generally referred to as propagation of unsafe conditions.

Because these unsafe conditions are often associated with excessive temperatures that the cells experience while being damaged, the propagation of unsafe conditions can be also referred to as a thermal runaway. As such, a thermal runaway and propagation of unsafe conditions are used interchangeably in this disclosure. In general, a thermal runaway is defined as a state in which a defect or failure causes a battery's rate of heat generated to exceed the rate of heat dissipated. High temperatures (e.g., above 180° C. for Li-metal cells) can cause further exothermic reactions, leading to additional heating. In extreme examples, cells can catch fire and even explode. In these instances, the internal components of the cell, including electrolyte, positive active materials, and metal lithium can be ejected from the cell casing and impinge on other cells within the battery assembly, causing these other cells to enter their thermal runaway. It should be noted that regardless of the naming convention, the concern with the discharge of lithium metal from one or more lithium-metal cells in a battery assembly and preventing this lithium metal from causing additional damage within the battery assembly and/or outside of the battery assembly.

It should be noted that any battery cells, including Li-metal cells, may fail at some point during their operations for various reasons. Because of unconstrained lithium on the negative electrodes and the constant plating and stripping of lithium metal on the negative electrodes, Li-metal cells are more prone than Li-ion cells to experience dendritic growth, which can cause short circuits. Furthermore, Li-metal cells can experience the increase in cell impedance due to the formation of porous lithium, which creates a more tortuous path for lithium-ions within the cell, increasing lithium-ion mean free path length and causing the cell impedance to increase.

This phenomenon is unique to Li-metal cells because charging these cells involves an electroplating process on the negative electrode. For comparison, lithium in Li-ion cells undergoes an intercalation process when captured and trapped by graphite of the negative electrode. Li-metal cells are also prone to various solid electrolyte interphase (SEI) side reactions and electrolyte reactions. Furthermore, when Li-metal cells are physically damaged, lithium metal can be exposed to the atmosphere.

As noted above, the ejection of lithium metal (e.g., molten lithium metal) is unique to Li-metal cells and can cause more a lot more severe unsafe conditions/thermal runaway events and much faster propagations. As such battery assemblies with lithium metal cells need to be specifically configured to address this lithium metal ejection. In particular, a battery assembly should be able to stop lithium metal from reaching and damaging other cells as well as wiring, battery management systems (BMS), and other components. In some examples, lithium metal also needs to be contained within the battery assembly without causing any further propagation of unsafe conditions outside of the assembly (e.g., other components of the battery pack or outside of the battery pack). In other examples, lithium metal can be vented out from the battery assembly, e.g., to keep the lithium metal away from any internal components of the battery assembly. This venting option depends on the operating environment of the battery assembly, e.g., whether the operating environment is capable of receiving the ejected lithium safely.

Described herein are battery assemblies that comprise lithium-metal electrochemical cells and lithium-ejecta containment components. A lithium-ejecta containment component is configured to prevent or at least reduce the migration of lithium metal ejected from any of the lithium-metal electrochemical cells with the battery assembly. This functionality is provided by various ways the lithium-ejecta containment component can block, redirect, and/or capture the ejected lithium metal. For example, a lithium-ejecta containment component can be positioned between a pair of lithium-metal electrochemical cells thereby blocking and preventing lithium metal ejected from one cell from reaching the other cell in this pair. In the same or other examples, a lithium-ejecta containment component is positioned between each cell and the battery-assembly enclosure and/or other non-cell components of the battery components. Specifically, the battery-assembly enclosure is blocked from lithium metal ejected from one or more cells, which helps to contain all ejected lithium metal within this assembly and to prevent the propagation to other assemblies, e.g., when each assembly is a battery module and when multiple battery modules are used in the same battery pack. Furthermore, a battery assembly can be surrounded by other non-battery components that can be damaged by the ejected lithium.

A lithium-ejecta containment component can be a standalone component or integrated into the battery-assembly enclosure, cell enclosures, and/or other battery assembly components. For example, a lithium-ejecta containment can form the external surface of each cell enclosure, the internal surface of the battery-assembly enclosure, and/or insulate the current-carrying component. In some examples, a lithium-ejecta containment component is configured to direct the ejected lithium metal away from the battery-assembly enclosure. For example, a lithium-ejecta containment component can form a vent or can form at least the internal surface of the vent. The vent can fluidically couple the battery assembly interior with an exterior (e.g., environment) outside the battery assembly and allow for the ejected lithium metal to travel to this exterior. In these examples, this exterior can safely receive the ejected lithium metal.

Various materials that are resistant to lithium and capable of withstanding high temperatures can be used for a lithium-ejecta containment component. For example, a lithium-ejecta containment component can be formed from one or more carbon, aluminum oxide, silicon carbide, silicon nitride, boron carbide, and boron nitride (or at least the surface of the lithium-ejecta containment component is formed from these materials). A lithium-ejecta containment component can be in various forms, such as a plate, a woven fabric, an aerogel, a collection of loose particles, a collection of loose fibers, or a coating. These materials and structures are capable of withstanding the contact with lithium metal (e.g., in a burning and/or molten form).

### Battery Assembly Examples

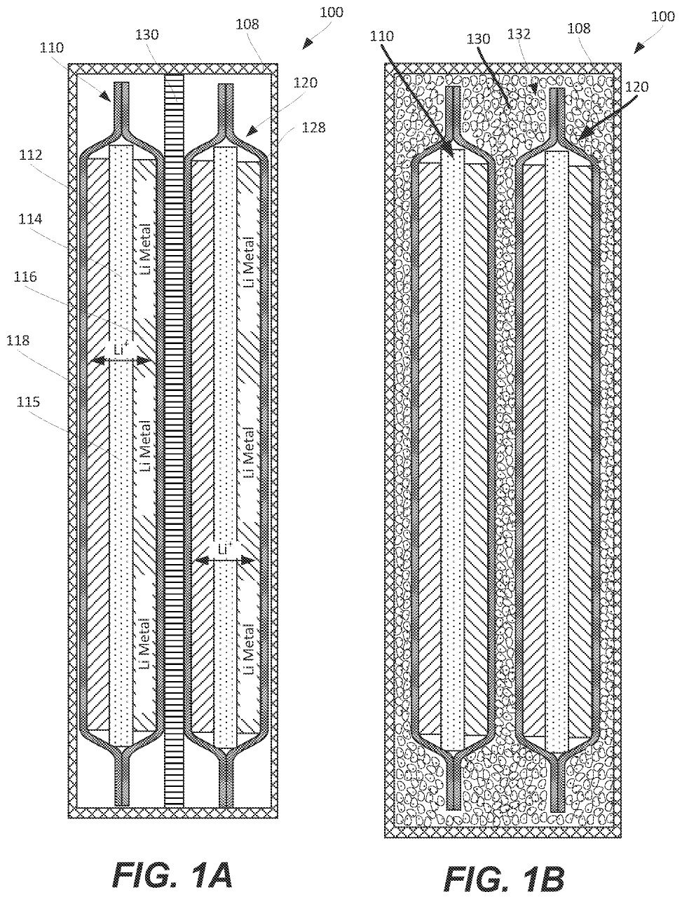

FIGS. 1A and 1B illustrate two examples of battery assembly 100, comprising lithium-metal electrochemical cells (e.g., first lithium-metal electrochemical cell 110 and lithium-ejecta containment component 120) and lithium-ejecta containment component 130. The structure of first lithium-metal electrochemical cell 110 and lithium-ejecta containment component 120 can be the same and will now be described with reference to first lithium-metal electrochemical cell 110.

Specifically, first lithium-metal electrochemical cell 110 comprises positive electrode 112, negative electrode 116, and separator 114 disposed between positive electrode 112 and negative electrode 116. Separator 114 allows the ionic transfer and provides the electronic insulation between positive electrode 112 and negative electrode 116. Separator 114 can be a solid-state separator, which may be also referred to as a solid-state electrolyte, effectively integrating the two functions in the same material. Some examples of suitable solid-state electrolytes for use with lithium-metal electrochemical cells include, but are not limited to, inorganic electrolytes, organic electrolytes, and composite electrolytes. Some examples of inorganic electrolytes include, but are not limited to, lithium superionic conductor (LISICON), argyrodite-like components, garnets (e.g., lithium lanthanum zirconium oxide), lithium nitrides (Li₃N), lithium hydrides (LiBH₄), lithium lanthanum titanate, lithium halides, lithium phosphorus oxynitride (LIPON), and lithium thiophosphate. Some examples of organic electrolytes include, but are not limited to, polyether-based electrolytes (e.g., polyethylene oxide-based ones), polycarbonate-based electrolytes, polyester-based electrolytes, polynitrile-based electrolytes, polyalcohol-based electrolytes, polyamine-based electrolytes, polysiloxane-based electrolytes, fluoropolymer-based electrolytes, and bio-polymer-based electrolytes. In other examples, first lithium-metal electrochemical cell 110 also comprises liquid electrolyte 115. Liquid electrolyte 115 soaks separator 114 and provides the ionic transfer. Some examples of liquid electrolyte 115 include, but are not limited to, a mixture of one or more lithium-containing salts and one or more solvents. Some examples of lithium-containing salts include, but are not limited to, lithium bis(fluorosulfonyl)imide (LiFSI), lithium bis(trifluoromethylsulfonyl)amide (UTFSI), lithium tetrafluoroborate (LiBF₄), lithium hexafluorophosphate (LiPF₆), lithium bis(oxalato)borate (LiBOB), lithium difluoro(oxalato)borate (LiDFOB), lithium trifluoromethanesulfonate (LiTf), lithium nitrate (LiNO₃), and various combinations thereof. More preferably, the lithium salt is LiFSI or LiTFSI, and most preferably LiFSI. Some examples of electrolyte solvents but are not limited to, one or more cyclic ethers (e.g., 1,3-dioxane (DOL), 1,4-dioxane (DX), tetrahydrofuran (THF)), one or more linear ethers (e.g., dimethoxyethane (DME), Bis(2-methoxyethyl) ether (G2), triethylene glycol dimethyl ether (G3), or tetraethylene glycol dimethyl ether (G4), Bis(2,2,2-trifluoroethyl)ether (BTFE); ethylal; 1,1,2,2-tetrafluoroethyl 2,2,3,3-tetrafluoropropyl ether (TFPE)), and combination thereof. Additional liquid-electrolyte components may include, but not limited to, metal salts (e.g., having bis(trifluoromethanesulfonyl)imide (TFSI), bis(fluorosulfonyl)imide (FSI), hexafluorophosphate (PF6), tetrafluoroborate (BF4), and/or bis(oxalate)borate (BOB) anions), ionic liquids (eg.., propyl-methyl-pyrrolidinium-FSI/TFSI; butyl-methyl-pyrrolidinium-FSI/TFSI; octyl-methyl-pyrrolidinium-FSI/TFSI, and any combination thereof), and the like.

Positive electrode 112 can include a current collector (e.g., an aluminum foil) and an active material layer comprising an active material (e.g., in a form of particles) and a binder (e.g., a polymer binder). Some examples of positive active materials include, but are not limited to, lithium nickel manganese cobalt (NMC) oxides, lithium iron phosphate, and the like. Some examples of suitable binders include, but are not limited to, polymer binders (e.g., polyvinylidene-fluoride (PVDF), styrene butadiene rubber (SBR), and carboxyl methyl cellulose (CMC)). In some examples, positive electrode 112 comprises a conductive additive (e.g., carbon black/paracrystalline carbon).

Negative electrode 116 can also include a current collector on which a lithium metal layer is deposited when first lithium-metal electrochemical cell 110 is charged. Some examples of suitable current collectors include, but are not limited to, copper, nickel, aluminum, stainless steel, a metalized polymer substrate (e.g., metalized with copper), a carbon-coated metal substrate. The purpose of using a negative electrode with a lithium-metal layer deposited on a current collector (in lithium-metal electrochemical cells) is to reduce the size of the negative electrode (e.g., in comparison to lithium-ion cells). For example, the thickness of the lithium-metal layer can be less than 20 micrometers. Furthermore, the addition of a current collector also helps to keep the thickness of the lithium-metal layer small. For example, the thicknesses of less than 20 micrometers are difficult to achieve with a freestanding lithium foil. As such, lithium-metal cells with negative electrodes formed by freestanding lithium foils/layers require substantially more lithium than lithium-metal cells with negative electrodes formed by a combination of a current collector and a lithium-metal layer (to achieve the same cell capacity). Lower amounts of lithium are highly desirable from the safety perspective as less lithium ejecta (e.g., molten lithium ejecta) needs to be contained when the cell goes into the thermal runaway.

Positive electrode 112, negative electrode 116, and separator 114 can be referred to as internal components of first lithium-metal electrochemical cell 110. These internal components are sensitive to moisture and other ambient conditions and insulated from the environment by cell enclosure 118. In some examples, cell enclosure 118 is formed from aluminum (e.g., for cylindrical or prismatic cells), a pouch laminate, an aluminum-coated polymer (e.g., polyamide, polyester, polyurethane, and polypropylene). Second lithium-metal electrochemical cell 120 has generally the same constructions and also comprises second cell enclosure 128.

When first lithium-metal electrochemical cell 110 and second lithium-metal electrochemical cell 120 are integrated into battery assembly 100, the cells can be positioned into battery-assembly enclosure 108. Some examples of battery-assembly enclosure 108 include, but are not limited to, a box, a cylinder, a wraparound band, and a loose pouch. Various materials for battery-assembly enclosure 108 are within the scope, such as steel, aluminum, and titanium. In some examples, battery-assembly enclosure 108 comprises a graphite coating, which may be operable as lithium-ejecta containment component 130.

Lithium-ejecta containment component 130 is provided within battery assembly 100 and is specially configured to prevent or at least reduce migration of lithium metal, ejected from any cells in battery assembly 100 (e.g., first lithium-metal electrochemical cell 110 and second lithium-metal electrochemical cell 120). As noted above, lithium metal is aggregated on the cell's negative electrodes while these cells are charging. At certain undesirable conditions, which are typically associated with a thermal runaway, the lithium metal can be ejected from one or more cells in battery assembly 100. In some examples, the lithium metal is in a molten state during this discharge. It should be noted that the melting temperature of lithium is 180° C., while the upper operating limit of the lithium-metal electrochemical cell is about 60-70° C. or even up to 80° C. for short periods. It should be noted that molten lithium is significantly more reactive than solid lithium metal and is more likely to cause a fire. Furthermore, molten lithium also conducts heat better (than solid lithium metal) when in contact with other materials as molten lithium wets other materials increasing the contact surface. As such, heat propagation greatly increases when lithium is in the molten state. It should be also noted that lithium metal can be also ejected in a solid form or solidify after the ejection (e.g., upon contact with internal components of battery assembly 100). Even in the solid, lithium metal remains chemically reactive and can cause electrical shorts.

Lithium-ejecta containment component 130 can prevent or at least reduce the lithium metal migration within battery assembly 100 in various ways. For example, lithium-ejecta containment component 130 can be positioned between first lithium-metal electrochemical cell 110 and second lithium-metal electrochemical cell 120 as, e.g., is schematically shown in FIGS. 1A and 1B. In this example, when lithium metal is ejected from one cell (e.g., first lithium-metal electrochemical cell 110), the lithium metal is unable to reach the other cell (e.g., second lithium-metal electrochemical cell 120). Any direct contact with the lithium metal can be damaging to the cell enclosure and can cause both internal and external shorts of the cell (e.g., if metal lithium reaches both terminals of the cells or causes internal cell damage). Furthermore, positioning lithium-ejecta containment component 130 between the cells helps to reduce the heat transfer from one cell to another. For example, lithium-ejecta containment component 130 can be formed from one or more thermally insulating materials, various examples of which are presented below. When the lithium metal is ejected from a cell, this cell typically goes through a thermal runaway with temperatures reaching and exceeding 1600° C.-2000° C., which is lithium burning temperature. If the heat is transferred to an adjacent cell, this cell can also enter a thermal runaway caused by the separator melting/internal shorts, electrolyte decomposition, and the like.

In some examples, when lithium-ejecta containment component 130 is positioned between first lithium-metal electrochemical cell 110 and second lithium-metal electrochemical cell 120, lithium-ejecta containment component 130 can extend to the interior surfaces of battery-assembly enclosure 108 and effectively forms two or more isolated compartments within battery assembly 100, e.g., one compartment containing first lithium-metal electrochemical cell 110 and another compartment containing second lithium-metal electrochemical cell 120.

In some examples, lithium-ejecta containment component 130 is positioned between battery-assembly enclosure 108 and each of first lithium-metal electrochemical cell 110 and second lithium-metal electrochemical cell 120 as, e.g., is schematically shown in FIG. 1B. In these examples, lithium-ejecta containment component 130 protects battery-assembly enclosure 108 from the lithium metal ejected from either cell. This approach allows forming battery-assembly enclosure 108 from various materials that are not resistant to lithium metal. Furthermore, lithium-ejecta containment component 130 can act as a thermal barrier and prevent excessive heating of battery-assembly enclosure 108 while one or more cells (with battery-assembly enclosure 108) are going through a thermal runaway.

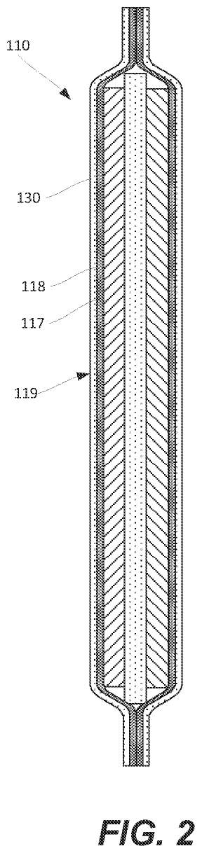

In some examples, lithium-ejecta containment component 130 is integrated into one or more battery-assembly enclosure 108, first cell enclosure 118, second cell enclosure 128, or any other internal component of battery assembly 100. For example, FIG. 2 illustrates an example where lithium-ejecta containment component 130 is integrated into first cell enclosure 118, forming exterior surface 119 of first cell enclosure 118. More specifically, first cell enclosure 118 comprises enclosure base 117 and lithium-ejecta containment component 130, forming exterior surface 119 of first cell enclosure 118. Some examples of materials suitable for enclosure base 117 include, but are not limited to, a polymer base or a metal (e.g., carbon fiber, aluminum, titanium, steel). Lithium-ejecta containment component 130 can be in a coating form and can comprise graphite, carbon fiber, ceramic, and/or aerogel.

This integration reduces the number of separate components needed for battery assembly 100 and potentially reduces the volume requirements. Furthermore, this integration can ensure the full coverage and protection of the component. For example, lithium-ejecta containment component 130 can be in the form of a coating, positioned on the external surface and/or internal surface of the cell enclosure and/or on the internal surface of battery-assembly enclosure 108. For example, lithium-ejecta containment component 130 can be formed from a mixture of non-flammable epoxy and particles, fibers, or other types of structures comprising carbon (e.g., in a form of graphite, carbon fiber), aluminum oxide, silicon carbide, silicon nitride, boron carbide, and boron nitride.

Alternatively, lithium-ejecta containment component 130 is a standalone component, e.g., as shown in FIGS. 1A and 1B. In these examples, the entire volume of lithium-ejecta containment component 130 can be formed from the same materials, e.g., carbon (e.g., in a form of graphite, carbon fiber), aluminum oxide, silicon carbide, silicon nitride, boron carbide, and boron nitride. For example, a carbon-fiber sheet or a ceramic plate can be used as lithium-ejecta containment component 130. In other examples, lithium-ejecta containment component 130 can comprise a base structure and a coating. The coating is disposed over the base structure forms at least a part of an exterior surface of lithium-ejecta containment component 130. The base structure comprises a first material, while the coating comprises a second material, different from the first material. For example, a base structure can be formed from a metal (e.g., steel) or some other structural components. The base structure may not be resistant (on its own) to lithium ejecta. The coating can be formed from a material that is resistant to lithium ejecta, such as carbon (e.g., in a form of graphite, carbon fiber), aluminum oxide, silicon carbide, silicon nitride, boron carbide, and boron nitride. The coating isolates and protects the base structure from lithium ejecta.

In some examples, lithium-ejecta containment component 130 is configured to absorb and contain ejected lithium metal within battery-assembly enclosure 108. For example, lithium-ejecta containment component 130 can have a porous structure, e.g., formed by loose structures (as schematically shown in FIG. 1B) or a solid porous structure. The pores are used to trap lithium metal as this lithium metal is ejected from one or more cells. In some examples, the porosity of lithium-ejecta containment component 130 is between about 10% and 99% or, more specifically, between 50% and 95%. In more specific examples, lithium-ejecta containment component 130 comprises aerogel with porosity up to 99%. In general, the porosity depends on the material of lithium-ejecta containment component 130. For example, lower porosity materials (e.g., a loose filling of carbon fibers, powder graphite, powder ceramic) can be used as lithium-ejecta containment component 130. More specifically, lithium-ejecta containment component 130 can be made from a collection of small structures, with each structure being non-porous. The porosity of this collection depends on the packing factor of these materials.

When lithium-ejecta containment component 130 is used as a containment component, the materials forming lithium-ejecta containment component 130 can have lithiophobic properties (e.g., repel lithium) or is at least lithium resistant. In more specific examples, when lithium-ejecta containment component 130 has a solid plate form, lithium would bounce off this plate as lithium cannot adhere to the material. In other examples, when lithium-ejecta containment component 130 is a loose powder or chunk form, lithium may bounce off of the individual particles but would get stuck in voids between these particles, i.e., in the greater loose structure. Lithium would essentially be trapped by the surrounding material. Depending on how tightly packed the material is, the loose structure would essentially form pockets of lithium wrapped in the containment component isolating the lithium ejecta from the rest of the module.

In some examples, lithium-ejecta containment component 130 comprises one or more carbon (e.g., in the form of carbon fiber and graphite), aluminum oxide, silicon carbide, silicon nitride, boron carbide, and boron nitride. These materials are not reactive with lithium metal. At least some of the materials have reductive stability to lithium and are lithiophobic (i.e., not make wetting contact with molten lithium). Aluminum oxide provides excellent heat shielding and can resist temperatures up to 1750° C. Silicon carbide and boron carbide are reductively stable to lithium (will not react well in contact with lithium) and are likely to have lithiophobic characteristics. Furthermore, silicon carbide has extremely strong ballistic characteristics and will resist well lithium projectile. Silicon nitride has a high-temperature resistance. Finally, various combinations of these materials can be used, e.g., combining a high mechanical strength material (e.g., silicon carbide) with a lithiophobic material (e.g., graphite coating). In another example, a ballistic material (e.g., silicon carbide) is used to withstand the blast/jet of ejecta is combined with another material to resist chemical reaction with the lithium metal

In some examples, lithium-ejecta containment component 130 has a form of one or more of a plate, a woven fabric, an aerogel, a collection of loose particles, and a collection of loose fibers. A plate or a fabric can provide a barrier between a cell and another assembly component (e.g., another battery, battery-assembly enclosure 108). A plate or a fabric is easy to handle during the fabrication of battery assembly 100. Furthermore, a fabric can be flexible and used to wrap various components of battery assembly 100.

When lithium-ejecta containment component 130 is in the form of loose particles and/or fibers as, e.g., is schematically shown in FIG. 1B, these particles and/or fibers can be added into battery-assembly enclosure 108 after positioning first lithium-metal electrochemical cell 110 and second lithium-metal electrochemical cell 120. For example, particles and/or fibers are used to fill any spaces between the cells and between battery-assembly enclosure 108, and each cell as, e.g., is schematically shown in FIG. 1B. Loose particles and/or fibers can provide high porosity levels and the ability to capture the ejected lithium metal without a significant increase in the total weight of battery assembly 100.

In some examples, lithium-ejecta containment component 130 is configured to withstand temperature and fire up to 1500° C., up to 1750° C., or even up to 2000° C. As noted above, molten lithium metal can burn at temperatures of 1200° C. or more. For example, aluminum oxide has a melting point of 2072° C., while silicon carbide has a melting temperature of 2730° C.

In some examples, lithium-ejecta containment component 130 has a lithium-wetting contact angle of at least 90° or, more specifically, at least 100° or even at least 120°. This lithium-wetting contact angle applies to the material of lithium-ejecta containment component 130 or, even more specifically, to the material forming a surface of lithium-ejecta containment component 130. With such poor wettability, the contact and the impact of molten lithium metal on lithium-ejecta containment component 130 are reduced. In some examples, the wetting angle can be changed using specific surface morphology (e.g., surface roughness).

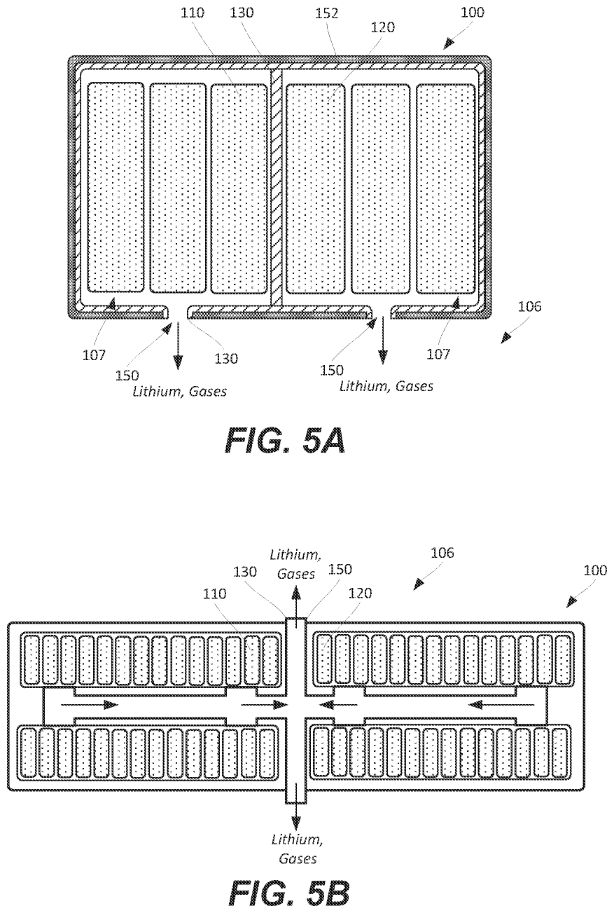

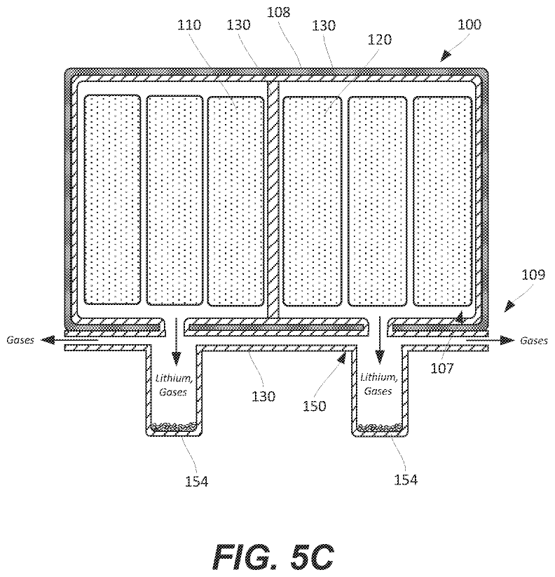

In some examples,lithium-ejecta containment component 130 comprises one or more voids 132, configured to absorb and contain the ejected lithium metal within battery-assembly enclosure 108. Voids 132 can be formed by pores in a solid structure or spaces between loose particles and/or fibers. In some examples, void 132 is a special enclosed volume within battery assembly 100, separated from the cells, and can be referred to as a trap. A special example of a trap is venting-port lithium trap 154 described above with reference to FIGS. 5A and 5B.

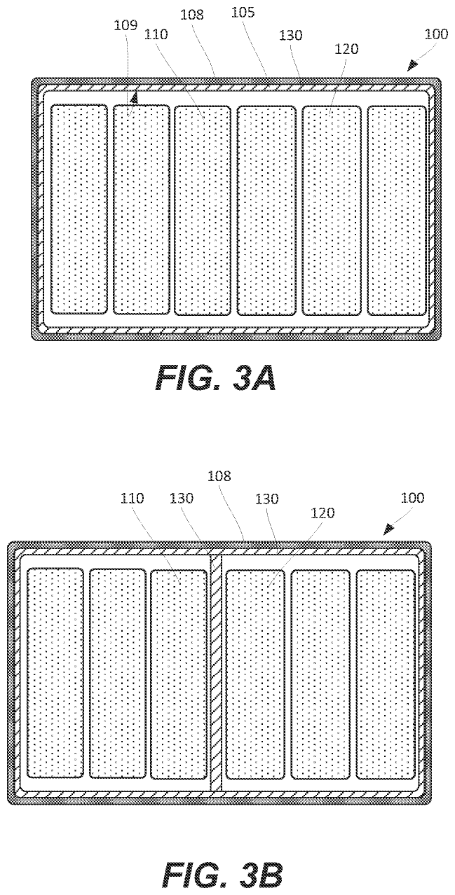

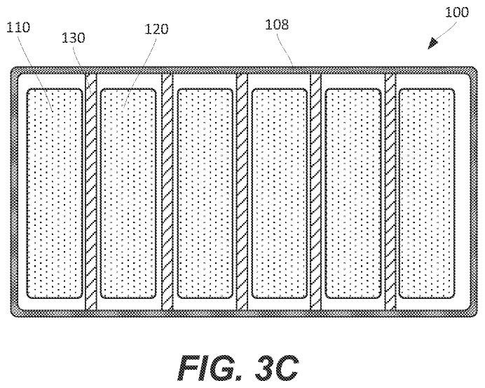

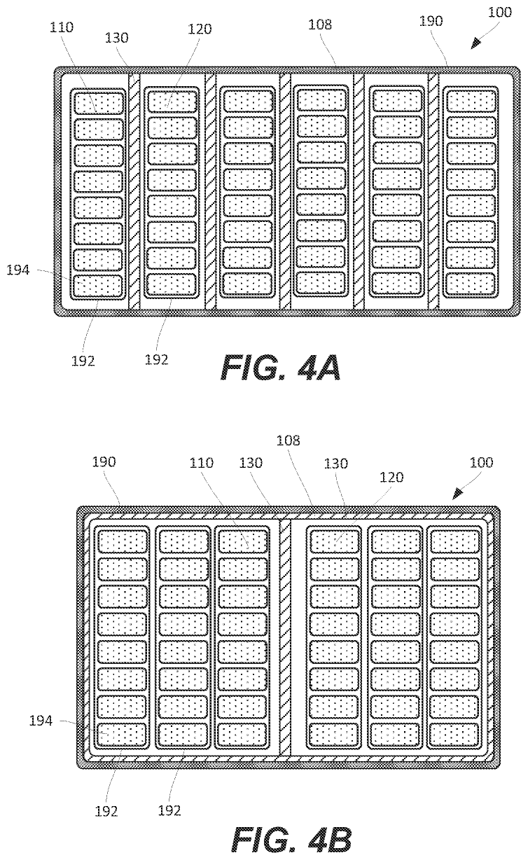

As noted above, battery assembly 100 can be in a form of a battery module (e.g., as schematically shown in FIGS. 3A-3C) and/or in a form of a battery pack (e.g., as schematically shown in FIGS. 4A and 4C). In other words, lithium-ejecta containment component 130 can be integrated into battery assembly 100 at a cell level, a module level, and/or a pack level. In some examples, a battery pack may include various structural components (e.g., for mounting the modules within the pack), venting features, and/or protective structures between individual modules in the pack.

Referring to FIG. 3A, in some examples, lithium-ejecta containment component 130 is integrated into battery-assembly enclosure 108. Specifically, battery-assembly enclosure 108 can comprise interior surface 109, facing first lithium-metal electrochemical cell 110 and second lithium-metal electrochemical cell 120. This interior surface 109 is formed at least in part by lithium-ejecta containment component 130. Specifically, FIG. 3A illustrates an example where the entire interior surface 109 is formed by lithium-ejecta containment component 130. In other examples, between 10% and 90% of interior surface 109 is formed by lithium-ejecta containment component 130 or, more specifically, between 20% and 80%.

For example, battery-assembly enclosure 108 can comprise base structure 105 and lithium-ejecta containment component 130, positioned on the interior surface of base structure 105. Base structure 105 can be formed from one or more of the following materials, steel (e.g., stainless steel), aluminum, and titanium. Lithium-ejecta containment component 130 can be deposited onto base structure 105 in a form of a coating.

Referring to FIG. 3B, in some examples, lithium-ejecta containment component 130 separates (e.g., extends between two sets of lithium-metal electrochemical cells). Each set can include multiple lithium-metal electrochemical cells that are otherwise are not separated from each other by lithium-ejecta containment component 130. For example, each set can include two, three, four, five, or more lithium-metal electrochemical cells. While a partial propagation of unsafe conditions may be possible within the set, lithium-ejecta containment component 130 blocks the propagation between the sets. This approach requires fewer lithium-ejecta containment components 130 for a given number of lithium-metal electrochemical cells without comprising the safety of the entire battery assembly 100 and still maintaining adequate safety levels.

Referring to FIG. 3B, in some examples, lithium-ejecta containment component 130 comprises multiple components, e.g., one integrated into battery-assembly enclosure 108 and another positioned between a pair of adjacent cells. One example of lithium-ejecta containment component 130 is integrated into a cell casing, e.g., a wrap, a box, a band, or a directed venting path around a single cell or group of cells. In some examples, a sub-module component can be used to prevent cell-to-cell propagation from spreading within a single module. Another example of lithium-ejecta containment component 130 is integrated into a module casing, e.g., a wrap, a box, a band, or a directed venting path around a full stack of cells or module level. Yet another example of lithium-ejecta containment component 130 is integrated into a pack casing, which may be similar to a module casing (described above), but for the pack level. In this example, lithium-ejecta containment component 130 prevents propagation from spreading to the system level. In yet another example, lithium-ejecta containment component 130 is integrated into an intercell component, e.g., a component positioned between cells within a module. This intercell component should be distinguished from a cell wrap-around and a cell case. Instead, the intercell component is a separate component positioned between cells. This intercell component prevents propagation in one or more linear directions between adjacent cells in a stack. In further examples, lithium-ejecta containment component 130 is integrated into wiring and electronics protection as further described below. For example, lithium-ejecta containment component 130 can be integrated into a protective wrap or a coating around wiring or electrical components (e.g., preventing lithium from destroying electrical monitoring or causing further external short circuits). In additional examples, lithium-ejecta containment component 130 is integrated into one or more venting ports (e.g., ports or areas designed for gas and lithium ejecta to escape from areas that would otherwise be damaged by lithium). Furthermore, lithium-ejecta containment component 130 can be integrated into a venting piping, e.g., piping or pathways designed for ejecta and gas to travel outside of the module (e.g., coating, wrapping, or creating piping out of lithium-ejecta containment component 130 prevents ejecta from escaping these piping structures and causing damage on the pack level). Various tradeoffs/benefits of these different approaches should be mentioned. For example, a higher integration level of lithium-ejecta containment component 130 (e.g., at pack-level vs cell-level) can have a lower weight, lower volume, and lower cost but may allow a higher propagation level (e.g., contain larger file and more ejected lithium).

Referring to FIG. 3C, in some examples, lithium-ejecta containment component 130 is configured such that any pair of adjacent lithium-metal electrochemical cells has lithium-ejecta containment component 130 positioned between these adjacent cells. For example, FIG. 3C illustrates five lithium-metal electrochemical cells and five lithium-ejecta containment components 130. In some examples, multiple lithium-ejecta containment components can be viewed as sub-components of one lithium-ejecta containment component 130. In these examples, lithium-ejecta containment component 130 helps to contain unsafe conditions to each individual lithium-metal electrochemical cell thereby minimizing the overall impact to battery assembly 100. For example, if one lithium-metal electrochemical cell experiences a thermal runaway, battery assembly 100 can continue to function, e.g., by disconnecting this particular lithium-metal electrochemical cell or a set of lithium-metal electrochemical cells from the remaining cells in battery assembly 100.

FIGS. 4A and 4B illustrate examples where battery assembly 100 is battery pack 190, comprising multiple battery modules 192 such that each of battery modules 192 comprising multiple lithium-metal electrochemical cells 194. First lithium-metal electrochemical cell 110 and second lithium-metal electrochemical cell 120 are parts of these multiple lithium-metal electrochemical cells 194. In these examples, lithium-ejecta containment component 130 is positioned between at least two of battery modules 192. More specifically, in FIG. 4A example, a subcomponent of lithium-ejecta containment component 130 is positioned between any pair of two adjacent battery modules 192. In FIG. 4B example, lithium-ejecta containment component 130 separates two sets of battery modules 192 such that battery modules 192 within each set are not separated from each other.

In some examples, the integration of one or more lithium-ejecta containment components 130 at the battery pack level can be combined with the integration of additional lithium-ejecta containment components 130 at the battery module level and/or at the cell level as described above with references to FIGS. 1A-3C,

In some examples, lithium-ejecta containment component 130 is configured to direct ejected lithium metal away from battery-assembly enclosure 108 as, e.g., is schematically shown in FIGS. 5A and 5B. Specifically, lithium-ejecta containment component 130 can at least partially form battery-assembly venting port 150. For example, battery-assembly venting port 150 protrudes through battery-assembly enclosure 108 and fluidically coupled interior 107 of battery-assembly enclosure 108 with environment 106. When lithium metal is ejected from one or more lithium-metal electrochemical cells, battery-assembly venting port 150 directs this lithium metal (as well as any other ejected materials such as gases created by burning, evaporation, and decomposition of various cell components) from battery-assembly enclosure 108 (and away from other cells) and into environment 106. In these examples, environment 106 provides safe capture of lithium metal. Some examples of environment 106 include the exterior of aircraft or at least outside of some aircraft systems. For example, an aircraft can include one or more dedicated areas for capturing lithium metal, e.g., empty, non-structural, protected areas.

In some examples, battery assembly venting port 150 is formed entirely by lithium-ejecta containment component 130, e.g., a carbon-fiber structure. Alternatively, assembly venting port 150 comprises a base structure 152, coated with lithium-ejecta containment component 130.

Referring to FIG. 5C, in some examples, assembly venting port 150 comprises a lithium trap 154, configured to minimize the discharge of ejected lithium metal to environment 106. For example, lithium trap 154 is used when lithium ejecta may not be ejected from battery assembly 100 (e.g., into the environment surrounding battery assembly 100). Lithium trap 154 allows lithium (e.g., molten lithium) to be stored for a substantial period without leading to additional damage within battery assembly 100. In some examples, lithium trap 154 is a tube that is coated with lithium-ejecta containment component 130. Alternatively, lithium trap 154 is formed entirely from lithium-ejecta containment component 130. Lithium trap 154 can hold hot lithium (e.g., molten lithium) until lithium cools without allowing lithium to escape from battery assembly 100. For example, battery assembly 100 can be used in an aircraft that does not allow lithium ejecta outside of battery assembly 100.

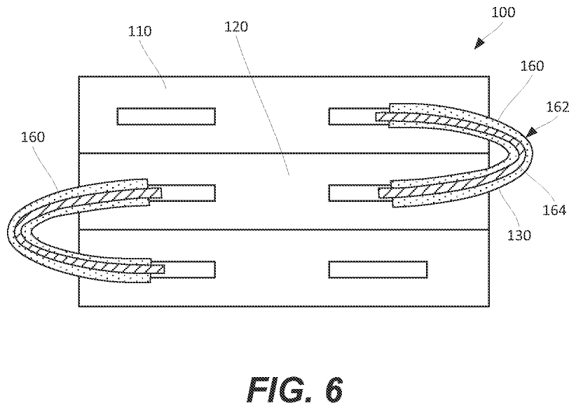

Referring to FIG. 6, in some examples, battery assembly 100 comprising current-carrying component 160, electrically coupled to first lithium-metal electrochemical cell 110 and second lithium-metal electrochemical cell 120. Lithium-ejecta containment component 130 can form forms external surface 162 of current-carrying component 160. For example, lithium-ejecta containment component 130 can be form from an electrically insulating material, such as TBD. Alternatively, lithium-ejecta containment component 130 can be insulated from conductive portion 164 of current-carrying component 160 by a non-conductive base structure, effectively forming a core-shell-shell structure.

### Application Examples

Battery assembly 100 comprising lithium-metal electrochemical cells and lithium-ejecta containment component 130 can be used for various applications, such as ground-based vehicles, boats, aircraft, and spacecraft. For example, aircraft and/or spacecraft use Li-metal batteries as such batteries have significantly higher gravimetric energy density than, e.g., Li-ion batteries. Both aircraft and spacecraft applications require lower mass cells, as additional mass leads to lower payload capacity. For these applications to utilize the maximum amount of their designed capacity, the energy system must be the lowest mass possible. In addition, safety is paramount in both of these applications, as onboard fires while in flight could be mission-critical and cause catastrophic failure of the system. In this scenario, occupants or personnel using the system are not able to simply depart from aircraft and/or spacecraft (e.g., in comparison to ground-based vehicles). As such, containing onboard fires and battery thermal runaway is important for these applications.

Safe Li-metal batteries offer electric aircraft a larger payload-range capability, greatly expanding market appeal. For example, aviation regulatory authorities (e.g., FAA in the US and EASA in Europe) have strict requirements for battery safety, which include cell-to-cell or module-to-module propagation prevention/mitigation that must be met for certification. Battery assemblies 100, described herein, provide improvement in energy density and safety, when compared to most-advances Li-ion batteries. For example, Li-metal batteries provide high energy density allowing these batteries or, more specifically, battery assemblies comprising Li-metal batteries to be deployed in various aircraft-related applications, e.g., unmanned aircraft systems (UAS) with longer flight times and to have substantially reduced risk of fire or in-flight break-up compared to current Li-ion batteries.

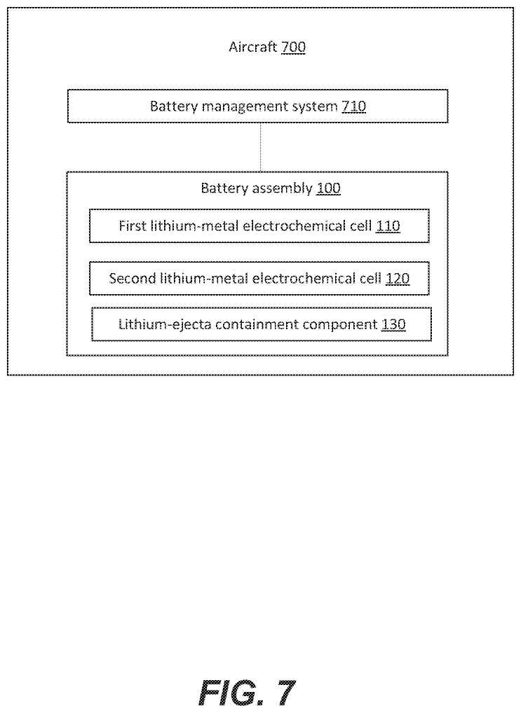

FIG. 7 is a block diagram of aircraft 700 comprising battery assembly 100, which in turn comprises first lithium-metal electrochemical cell 110, second lithium-metal electrochemical cell 120, and lithium-ejecta containment component 130. Aircraft 700 also comprises battery management system 710, electrically and communicatively coupled to battery assembly 100. For example, battery management system 710 can receive various operating signals from battery assembly 100, such as state of charge, temperature, voltage, current, and the like. Battery management system 710 can detect a thermal runaway experienced by first lithium-metal electrochemical cell 110 and/or second lithium-metal electrochemical cell 120 and, if needed, electrically disconnect the unsafe cell.

### Experimental Data

A set of tests was conducted to determine the effect of adding lithium-ejecta containment components into battery assemblies. All tested battery assembly included multiple lithium-metal cells with different types of structures positioned between adjacent cells. Specifically, one battery assembly uses 0.79-mm thick carbon-fiber plates, another battery assembly used a steel foil coated with a graphite coating (a combined thickness of about 0.79 millimeters), and yet another battery assembly used a titanium plate. A thermal runaway was triggered in each battery assembly causing lithium ejecta directed toward these tested containment components. The carbon-fiber plates and graphite-coated steel foil showed no penetration and were able to block all lithium ejecta. Specifically, the graphite-coated steel foil remained effectively intact. On the other hand, the titanium plate failed in containing lithium ejecta. A large portion of the titanium plate melted upon contact with the lithium ejecta allowing the lithium ejecta to pass through the plate.

### Conclusion

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

1. A battery assembly comprising:
a battery-assembly enclosure;
a first lithium-metal electrochemical cell, comprising a first cell enclosure;
a second lithium-metal electrochemical cell, comprising a second cell enclosure; and
a lithium-ejecta containment component, configured to prevent or at least reduce migration of lithium-metal ejecta, expelled from at least one of the first lithium-metal electrochemical cell and the second lithium-metal electrochemical cell, within the battery assembly,
wherein the lithium-ejecta containment component is at least one of:
positioned between the first lithium-metal electrochemical cell and the second lithium-metal electrochemical cell,
positioned between the battery-assembly enclosure and each of the first lithium-metal electrochemical cell and the second lithium-metal electrochemical cell,
integrated into one or more of the battery-assembly enclosure, the first cell enclosure, the second cell enclosure,
configured to absorb and contain the ejected lithium metal within the battery-assembly enclosure, and
configured to direct the ejected lithium metal away from the battery-assembly enclosure.

2. The battery assembly of claim 1, wherein the lithium-ejecta containment component comprises one or more of carbon, aluminum oxide, silicon carbide, silicon nitride, boron carbide, and boron nitride.

3. The battery assembly of claim 1, wherein the lithium-ejecta containment component comprises one or more of graphite and carbon fibers.

4. The battery assembly of claim 1, wherein the lithium-ejecta containment component has a form of one or more of a plate, a woven fabric, an aerogel, a collection of loose particles, and a collection of loose fibers.

5. The battery assembly of claim 1, wherein the lithium-ejecta containment component comprises loose fibers, filling spaces inside the battery assembly comprising a space between the first lithium-metal electrochemical cell and the second lithium-metal electrochemical cell.

6. The battery assembly of claim 1, wherein:
the lithium-ejecta containment component comprises a base structure and a coating,
the coating is disposed over the base structure forms at least a part of an exterior surface of the lithium-ejecta containment component,
the base structure comprises a first material,
the coating comprises a second material, different from the first material.

7. The battery assembly of claim 6, wherein:
the first material is metal, and
the second material is one or more of carbon, aluminum oxide, silicon carbide, silicon nitride, boron carbide, and boron nitride.

8. The battery assembly of claim 6, wherein the base structure is a part of at least one of:
a cell enclosure of the first lithium-metal electrochemical cell, and
an assembly enclosure of the battery assembly.

9. The battery assembly of claim 6, wherein the lithium-ejecta containment component is a standalone component, separate from other components of the battery assembly.

10. The battery assembly of claim 1, wherein:
the lithium-ejecta containment component is a standalone component, separate from other components of the battery assembly,
an entire volume of the lithium-ejecta containment component is formed from the same material comprising at least one of carbon, aluminum oxide, silicon carbide, silicon nitride, boron carbide, and boron nitride.

11. The battery assembly of claim 10, wherein the lithium-ejecta containment component is one of a carbon-fiber sheet and a ceramic plate.

12. The battery assembly of claim 1, wherein the lithium-ejecta containment component comprises voids, configured to absorb and contain the ejected lithium metal within the battery-assembly enclosure.

13. The battery assembly of claim 1, wherein the lithium-ejecta containment component is configured to withstand temperature and fire up to 2000° C.

14. The battery assembly of claim 1, wherein the battery-assembly enclosure comprises an interior surface, facing the first lithium-metal electrochemical cell and the second lithium-metal electrochemical cell and is formed at least in part by the lithium-ejecta containment component.

15. The battery assembly of claim 1, wherein:
the lithium-ejecta containment component at least partially forms a battery-assembly venting port, and
the battery-assembly venting port protrudes through the battery-assembly enclosure and fluidically coupled an interior of the battery-assembly enclosure with an environment.

16. The battery assembly of claim 15, wherein the assembly venting port comprises a venting-port lithium trap, configured to minimize the discharge of the ejected lithium metal to the environment.

17. The battery assemblyof claim 1, further comprising a current-carrying component wherein:
the current-carrying component is electrically coupled to the first lithium-metal electrochemical cell and the second lithium-metal electrochemical cell and
the lithium-ejecta containment component forms an external surface of the current-carrying component.

18. The battery assembly of claim 1, wherein:
each of the first lithium-metal electrochemical cell and the second lithium-metal electrochemical cell comprises a cell enclosure, having an exterior surface and
the lithium-ejecta containment component forms at least a portion of the exterior surface of the cell enclosure.

19. The battery assembly of claim 1, wherein each of the first lithium-metal electrochemical cell and the second lithium-metal electrochemical cell is a pouch cell.

20. The battery assembly of claim 1, wherein each of the first lithium-metal electrochemical cell and the second lithium-metal electrochemical cell comprises liquid electrolyte.
